(19) United States
(12) Patent Application Publication
(10) Pub. No.: US 2017/0341693 A1
(43) Pub. Date: Nov. 30, 2017

(54) PIVOTABLE ADAPTOR FOR A SADDLE-TYPE SEAT

(71) Applicant: Josef Rzepecki, Byron, MI (US)

(72) Inventor: Josef Rzepecki, Byron, MI (US)

(21) Appl. No.: 15/604,801

(22) Filed: May 25, 2017

Related U.S. Application Data
(60) Provisional application No. 62/343,236, filed on May 31, 2016.

(51) Int. Cl. B62J 1/28; B62J 7/04

(52) U.S. Cl. CPC B62J 1/28; B62J 7/04

(57) ABSTRACT

A pivotable adaptor is provided for an accessory coupled to a vehicle, such as a backrest and/or baggage system, where the accessory is positioned adjacent a saddle-type seat on the vehicle. A first member is configured to couple to the vehicle and a second member is configured to couple to the accessory, where the second member is pivotably coupled to the first member and is configured to pivot away from the saddle-type seat on the vehicle. The adaptor can be used in conjunction with a pivotable accessory, a vehicle, and in a method of improving access to a saddle-type seat on a vehicle. The pivotable adaptor thereby improves access for an operator and/or a passenger with respect to a saddle-type seat on a vehicle having a backrest and/or baggage system.

### CROSS-REFERENCE TO RELATED APPLICATIONS

This application claims the benefit of U.S. Provisional Application No. 62/343,236, filed on May 31, 2016. The entire disclosure of the above application is incorporated herein by reference.

### FIELD

The present technology relates to improving access to a seat that is positioned between the legs of a user, such as a saddle-type seat, where the seat includes a backrest and/or baggage system, and more particularly to a pivotable adaptor configured to improve access to a motorcycle seat fitted with a backrest and/or baggage system.

### INTRODUCTION

This section provides background information related to the present disclosure which is not necessarily prior art.

Various transportation devices and vehicles are outfitted with a seat that is positioned between the legs of an operator and/or passenger, where the operator and/or passenger straddles the seat. This type of seat can be described as a saddle-type seat, where the operator and/or passenger typically swings one leg over and/or around a portion of the saddle-type seat or a portion of the vehicle when getting on and off of the saddle-type seat. One common vehicle with a saddle-type seat is a motorcycle, where the saddle-type seat can be configured to accommodate an operator or can be configured to accommodate the operator and a passenger. Other types of vehicles with saddle-type seats include bicycles, scooters, trikes, all-terrain vehicles (ATVs), snowmobiles, and personal water craft (PWC).

Various motorcycles, scooters, and similar vehicles are popular vehicles for general transportation, including commercial delivery and recreational purposes. Various accessories are available to increase the utility and the comfort of these types of vehicles. Examples of such accessories include a backrest and/or baggage system. The backrest can be configured to support a portion of the back of the operator or passenger, allowing one to lean against the backrest and reduce fatigue experienced by sitting or traveling on the vehicle for a length of time. Backrests can include various bolsters and armrests and can be of various heights, providing support ranging from the small of the back to the upper back or even upper spine and/or shoulders. Baggage or luggage systems can include one or more types of various hard-sided or soft-sided containers, including various racks or attachment points for one or more various additional accessories. Certain combination backrest and baggage systems integrate a backrest and a baggage container into a single or modular unit with interchangeable components. The backrest, baggage system, or combination backrest-baggage system can be mounted to the vehicle using one or more mounts, including the operator seat mount, passenger seat mount, and/or another mount to another portion of the vehicle, such as a mount coupled to the vehicle frame, suspension, fender, etc. The baggage system can further include a luggage rack that extends outward and/or rearward of the vehicle or the baggage system can be coupled to such a luggage rack.

Depending on the configuration and style, the backrest and/or baggage system can present a considerable obstacle to the operator and/or the passenger when attempting get on and/or off of the saddle-type seat. In particular, in getting on or off the seat, one typically lifts a leg over and/or around a portion of the seat, where the user, being the operator or passenger, is typically straddling the seat when in the sitting position. A backrest and/or baggage system can therefore interfere with getting on and off of the seat and can further present a clearance issue or an awkward window for getting on and off of the seat. For example, it may be natural for certain users to swing a relatively straight leg over the seat to effectively straddle the seat, but the backrest and/or baggage system may require the user to significantly bend a knee or partially crawl over the seat. This can present an issue with stability of the vehicle, especially as motorcycles, scooters, and similar two-wheeled vehicles may be balanced only by a kickstand, or in the case of a boarding passenger, balanced using a foot of an operator that is already seated on the vehicle. Inability to maintain balance of the vehicle when a user is getting on or off of the vehicle can cause the vehicle to fall over and drop on its side.

Accordingly, there is a need to improve access for an operator and/or a passenger with respect to saddle-type seat on a vehicle that includes a backrest and/or baggage system.

### SUMMARY

The present technology includes articles of manufacture, systems, and processes that relate to pivoting an accessory, such as a backrest and/or baggage system, away from a saddle-type seat to facilitate getting on to and off of the saddle-type seat.

A pivotable adaptor is provided for an accessory coupled to a vehicle, where the accessory is positioned adjacent a saddle-type seat on the vehicle. The pivotable adaptor includes a first member and a second member. The first member is configured to couple to the vehicle. The second member is configured to couple to the accessory. The second member is pivotably coupled to the first member and is configured to pivot away from the saddle-type seat on the vehicle. A pivotable accessory is provided that is configured to be positioned adjacent a saddle-type seat on a vehicle. The pivotable accessory includes an accessory, such as a backrest and/or baggage system, and a pivotable adaptor, as described herein. A vehicle is provided that includes a saddle-type seat and a pivotable accessory positioned adjacent the saddle-type seat, where the saddle-type seat can be an operator seat or a passenger seat of a motorcycle. A method of improving access to a saddle-type seat on a vehicle is provided, where a pivotable accessory is positioned adjacent the saddle-type seat. The method includes pivoting the pivotable accessory away from the saddle-type seat. The method can employ the pivotable accessory with the pivotable adaptor and can include using the vehicle having a saddle-type seat and a pivotable accessory positioned adjacent the saddle-type seat, as described herein.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side elevational view of a vehicle with a saddle-type seat and a pivotable accessory including a first embodiment of a pivotable adaptor according to the present technology, where the pivotable accessory is a combination backrest and baggage system shown in an non-pivoted position.

FIG. 2 is a side elevational view of the vehicle of FIG. 1, where the pivotable accessory including the first embodiment of the pivotable adaptor is shown in a pivoted position.

FIG. 3 is a perspective view the first embodiment of the pivotable adaptor shown in FIGS. 2 and 3, where a first member is configured to be coupled to the vehicle and a second member is configured to be coupled to the pivotable accessory.

FIG. 4 is a perspective view showing the underside of a second embodiment of a pivotable adaptor in a non-pivoted position.

FIG. 5 is a perspective view showing a side elevation of the second embodiment of the pivotable adaptor in the non-pivoted position.

FIG. 6 is a perspective view showing a rear three-quarter view of the second embodiment of the pivotable adaptor in a pivoted position.

FIG. 7 is a cross-sectional view of the embodiment of the second embodiment of the pivotable adaptor in the pivoted position.

FIG. 8 is a perspective view showing a rear three-quarter view of a third embodiment of a pivotable adaptor in a partially pivoted position

FIG. 9 is a perspective view showing a front three-quarter view of the third embodiment of the pivotable adaptor in the partially pivoted position.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves access to a seat of a vehicle, including a seat that is positioned between the legs of a user, such as a saddle-type seat, where the seat has an accessory positioned nearby, such as a backrest and/or baggage system. Seats of various vehicles, including motorcycles, bicycles, scooters, trikes, all-terrain vehicles (ATVs), snowmobiles, and personal water craft (PWC), are often designed to be straddled by the user as a portion of the vehicle may extend between the user's legs. Various portions of the vehicle may require the user to swing a leg over the seat to get on and off the seat as the front of the seat may be blocked by a gas tank, vehicle frame, engine, transmission, or another part of the vehicle, for example. In particular, a pivotable adaptor is provided that can improve access to the seat for an operator or a passenger of the vehicle fitted with an adjacent or nearby accessory, such as a motorcycle fitted with a backrest and/or baggage system. The pivotable adaptor can pivot the accessory away from the seat making it easier to get on and off of the seat. Clearance and access for getting on and off of the seat is improved in the pivoted position. By improving access, one can get on or off the seat more quickly and more smoothly, where it can also be easier to maintain balance of the vehicle. Operators or passengers with limited limb mobility can also benefit from the improved clearance and access.

In certain embodiments, the present technology provides a pivotable adaptor for an accessory coupled to a vehicle, the accessory positioned adjacent a saddle-type seat on the vehicle, where the pivotable adaptor can include a first member and a second member. The first member can be configured to be coupled to the vehicle. The second member can be configured to be coupled to the accessory. The second member can be pivotably coupled to the first member and can be configured to pivot away from the saddle-type seat on the vehicle. In pivoting away from the saddle-type seat on the vehicle, the second member pivots the accessory away from the saddle-type seat and improves access for a user getting on or off of the saddle-type seat, where the user can be the vehicle operator and/or a passenger.

The first and second members of the pivotable adaptor can be configured in various ways. The first member can comprise a planar plate and/or the second member can comprise a planar plate. For example, the first member can include a first planar plate and the second member can include a second planar plate. The first member can be configured to be coupled directly to the vehicle or can be configured to be coupled to a mount or adaptor that can be directly coupled to the vehicle. For example, the first member can have a standard or universal configuration where one or more mounts or adaptors are coupled thereto in order to attach the first member to a particular vehicle. Such mounts and adaptors can be specific for certain makes, models, and types of vehicles and/or saddle-type seat configurations. The first member can include various attachment points and apertures designed to accept various types of mounting hardware, fasteners, clamps, locking devices, quick-release devices, etc. Where the first member includes a planar plate, the planar plate can include one or more attachment points and/or apertures for coupling to the vehicle, or the first member can include one or more additional portions, such as mounting members, attached to or integrally formed with the planar plate for coupling the first member to the vehicle. For example, the first member can include two mounting members extending downward in a generally orthogonal direction to the planar plate, where the mounting members can include one or more attachment points and/or apertures for coupling to the vehicle.

The second member can be configured to pivot from a first position adjacent the first member to a second position away from the second member and away from the saddle-type seat on the vehicle. At least a portion of each of the first member and the second member can be substantially parallel in the first position. The second member can overlap or cover a portion of the first member when in the first position. For example, the second member can lay atop and directly contact or nearly contact the first member in the first position.

When the second member is pivoted away from the saddle-type seat on the vehicle, the first member and the second member can define an angle therebetween in the second position, where the angle can change with the extent that the second member is pivoted away from the saddle-type seat. For example, the first member and the second member can pivot relative to each other from an angle greater than 0 degrees to an angle of greater than 90 degrees. The second member can be pivotably coupled to the first member to continuously move through an arc to a desired angle, or the second member can be pivotably coupled to the first member to stop at various preset angles. For example, the second member could pivot to a first stop at a 60 degree angle relative to the first member, a second stop at a 90 degree angle relative to the first member, and a third stop at a 120 degree angle relative to the first member. The extent to which the second member pivots away from the saddle-type seat can therefore be adjusted or selected by the user. Examples of various pivot angles include ranges from greater than 0 degrees to greater than 180 degrees, from greater than 0 degrees to 90 degrees, and examples of various stops include ranging from greater than 0 degrees to 180 degrees, including particular stops at 45 degrees, at 60 degrees, at 75 degrees, at 90 degrees, at 120 degrees, at 135 degrees, and at 180 degrees. Further examples include where the first member and the second member define an angle of at least about 60 degrees in the second position and at least about 90 degrees in the second position.

The second member can be configured to be coupled directly to the accessory or can be configured to be coupled to a mount or adaptor that can be directly coupled to the accessory. For example, the second member can have a standard or universal configuration where one or more mounts or adaptors are coupled thereto in order to attach the particular accessory to the second member. Such mounts and adaptors can be specific for certain makes, models, and types of accessories and accessory configurations, including various backrests and/or baggage systems. The second member can include various attachment points and apertures designed to accept various types of mounting hardware, fasteners, clamps, locking devices, quick-release devices, etc. for coupling the accessory thereto.

The first and second members can be pivotably coupled in various ways. For example, the first member and the second member can be pivotably coupled by a hinge. Various hinges can be employed, including a barrel hinge, a butt/mortise hinge, a continuous or piano hinge, a butterfly hinge, flag hinge, strap hinge, living hinge, etc. The first member and the second member can also be pivotably coupled by a pivot joint, a geared connection, and can include various bearings, bushings, and/or couplings that allow pivoting about a fixed axis. Various types of pivot hinges can be used that include a hold-open feature that can include a key or pin to lock the hinge at a particular position, such as the aforementioned first and second positions of the second member and/or various stops, including predefined stops, throughout the pivot arc of the second member. The second member can be pivotably coupled to the first member in other ways, including use of one or more ball and socket joints or universal joints to allow pivoting in more than one dimension.

The pivotable adaptor can further include a limiter configured to limit a distance that the second member can pivot away from the saddle-type seat on the vehicle. For example, the limiter can be coupled to the first member, the second member, or both the first and second members. The limiter can be configured as a wire having a fixed or adjustable length having ends coupled to the first member and the second member. The limiter can also be configured to abut the second member and limit how far the second member can pivot away from the saddle-type seat on the vehicle. In certain cases, the limiter can be configured as part of the pivotable coupling between the first member and the second member. The limiter can also be configured to interact as part of the pivotable coupling between the first member and the second member. In particular, the limiter can include or work in conjunction with a pivot hinge with a hold-open feature that can include a key or pin to lock the hinge at a particular position, such as the aforementioned first and second positions of the second member and/or various stops, including predefined stops, throughout the pivot arc of the second member.

The pivotable adaptor can further include a catch configured to prevent the second member from pivoting with respect to the first member. The catch can be configured to lock the second member with respect to the first member and can be configured to release the second member with respect to the first member. In this way, the catch can be operated in order to allow the second member to pivot away from the saddle-type seat on the vehicle. The same catch or an additional catch can also be used to lock the second member away from the saddle-type seat on the vehicle, where the catch can be operated to allow the second member to return toward the saddle-type seat on the vehicle. For example, one or more catches can be used to lock the second member in the first position and/or the second position relative to the first member. The catch can thereby prevent inadvertent or undesired pivoting of the second member with respect to the first member.

The pivotable adaptor can further include an anti-vibration device configured to prevent vibration of the first member and/or the second member. The anti-vibration device can contact the first member and/or the second member. For example, the anti-vibration device can include one or more spring-loaded devices that are positioned between the first member and the second member. Pressure on the spring loaded device between the first member and the second member can load the spring loaded device and dampen movement between the first and second members. Other types of anti-vibration devices can be used, including various rubber and/or spring mounts and dampers, various bushings including rubber and/or polymeric bushings, and sheets, bodies, protuberances, or strips formed of flexible materials such as elastomers, gels, rubber, cork, air bladders, foamed materials, and laminate materials. Other mechanical anti-vibration devices include shock absorbers and struts. In this way, noise, vibration, and harshness can be reduced in the pivotable adaptor. Stress and wear in the pivotable adaptor and any coupled accessories can also be minimized by the anti-vibration device.

The pivotable adaptor can further include an actuator configured to pivot the second member with respect to the first member and the saddle-type seat on the vehicle. The actuator can include various types of motors configured to operate the pivotable coupling of the first and second members. In particular, the actuator can cause the second member to pivot away from the saddle-type seat and back toward the saddle-type seat, where the actuator returns the second member from its pivoted position. The actuator can be pivotably coupled to the pivotable adaptor and can be configured to rotate or pivot with respect to one of the first member, second member, and both the first and second members. For example, the actuator can be pivotably coupled to the first member so that the actuator can move as it works to pivot the second member, where the second member pivots away from the saddle-type seat or back toward the saddle-type seat. More than one actuator can be used, where the actuators work in concert or a first actuator is used to pivot the second member away from the saddle-type seat and a second actuator is sued to pivot the second member toward the saddle-type seat. Various actuators can be used, including those operating on electric current, hydraulic fluid pressure, or pneumatic pressure. A remote or local switch can be used to operate the actuator and/or the actuator can be configured to receive a wireless signal to pivot the second member with respect to the first member.

In certain embodiments, the actuator can be a linear actuator powered by an electric motor that converts electrical energy into mechanical torque. Actuator configurations include screw jack, ball screw, and roller screw actuators and hoist, winch, rack and pinion, chain drive, belt drive, rigid chain, and rigid belt actuators. For example, the actuator can have a rack and pinion mechanism to translate rotational motion by the electric motor into linear motion. The actuator can be coupled to one of the first member and the second member and the actuator can include a translation member coupled to the other of the first member and the second member, where the actuator is configured to move the translation member thereby pivoting the second member of the pivotable adaptor with respect to the first member of the pivotable adaptor. For example, the translation member can include or be coupled to the rack of a rack and pinion actuator. The translation member can include a distal end where the actuator is configured to move the translation member by changing a distance between the distal end of the translation member and a remainder of the actuator. The actuator, in this manner, can extend and retract the translation member and change the distance between the distal end of the translation member and the remainder of the actuator to cause the second member to pivot away from the saddle-type seat and back toward the saddle-type seat.

Other aspects of the actuator include the following. The actuator can be configured to provide the necessary torque to pivot the accessory (e.g., backrest and/or baggage system) and any luggage or cargo stowed therein or thereon. A movement limit of the translation member can act as the aforementioned limiter to limit a distance that the second member can pivot away from the saddle-type seat on the vehicle. The pivotable adaptor can further include a pivot point between the first member and the second member about which the second member is pivotably coupled to the first member and is configured to pivot away from the saddle-type seat on the vehicle, where one of the actuator and the translation member extends across the pivot point. In this way, the actuator and translation member can apply a pivoting force between the first and second members. The actuator can be configured to be powered by the vehicle, for example, where the actuator is electrically coupled to an electrical system or battery of the vehicle. The pivotable adaptor can include a cut-off switch configured to render the actuator inoperable when the vehicle is in operation. The cut-off switch can be incorporated into the actuator or into the electrical coupling of the actuator to the electrical system or battery of the vehicle. In this manner, the cut-off switch can disconnect power to the actuator when the vehicle is operating, thereby preventing the second member from pivoting away from the saddle-type seat on the vehicle when the vehicle is in operation. Where the actuator is configured to receive a wireless signal to pivot the second member with respect to the first member, the actuator can include or be couple to a wireless receiver for communication vehicle 110 and/or the saddle-type seat 115 a remote control, a Bluetooth™ signal, a smart phone application, a proximity detector, a key fob for the vehicle, etc.

In certain embodiments, the present technology provides a pivotable accessory configured to be positioned adjacent a saddle-type seat on a vehicle. The pivotable accessory includes an accessory and a pivotable adaptor. The pivotable adaptor can be configured as described herein. The accessory can be a backrest and/or a baggage system. The pivotable accessory can further include a mount, where the first member of the pivotable adaptor can be configured to couple to the mount and the mount can be configured to couple to the vehicle. The pivotable accessory can be configured to be coupled directly to the mount and the pivotable adaptor can indirectly couple the accessory to the mount. For example, the pivotable adaptor can be removed and the accessory directly coupled to the mount. Conversely, an existing accessory and mount can be retrofitted with a pivotable adaptor. In this way, the pivotable adaptor can be retrofitted onto a vehicle having a saddle-type seat and an accessory (e.g., a backrest and/or a baggage system) adjacent the seat. The pivotable adaptor thereby transforms the accessory into a pivotable accessory to improve access to the seat by an operator and/or passenger.

In certain embodiments, the present technology provides a vehicle comprising a saddle-type seat and a pivotable accessory positioned adjacent the saddle-type seat. The pivotable accessory can be configured as described herein and can include a pivotable adaptor as described herein. The vehicle can include a motorcycle, bicycle, scooter, trike, all-terrain vehicle (ATV), snowmobile, personal water craft (PWC), or another vehicle having a saddle-type seat, where the seat can be configured for an operator and/or a passenger.

In certain embodiments, the present technology provides a method of improving access for a user to a saddle-type seat on a vehicle, where a pivotable accessory is positioned adjacent the saddle-type seat. The method includes pivoting the pivotable accessory away from the saddle-type seat. The pivotable accessory can be configured as described herein, where the pivotable accessory can include a pivotable adaptor as described herein. Pivoting the pivotable accessory away from the saddle-type seat can include pivoting the second member of the pivotable adaptor away from the saddle-type seat on the vehicle. The method can further include one of the user getting onto the saddle-type seat and the user getting off of the saddle-type seat when the second member is pivoted away from the saddle-type seat on the vehicle.

### Examples

Example embodiments of the present technology are provided with reference to the several figures enclosed herewith.

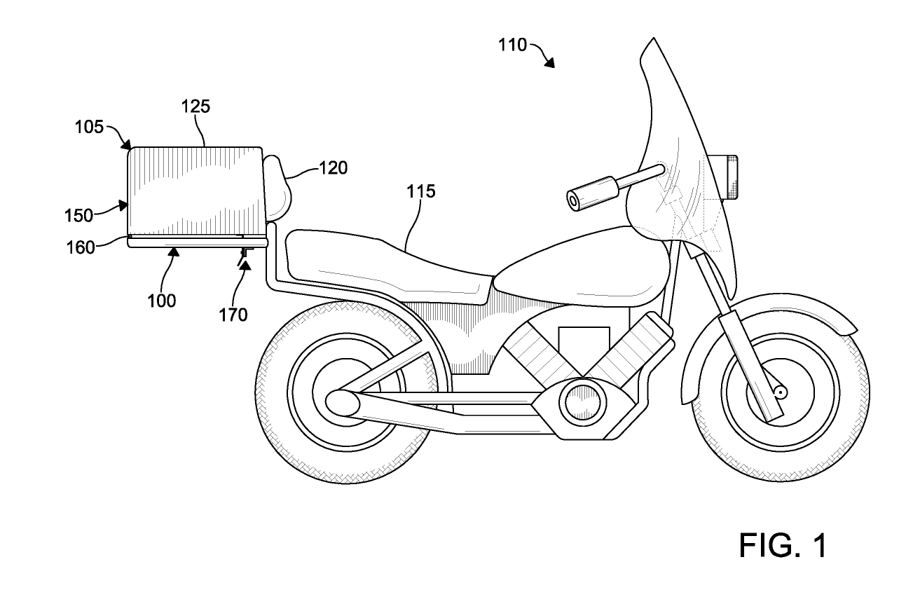

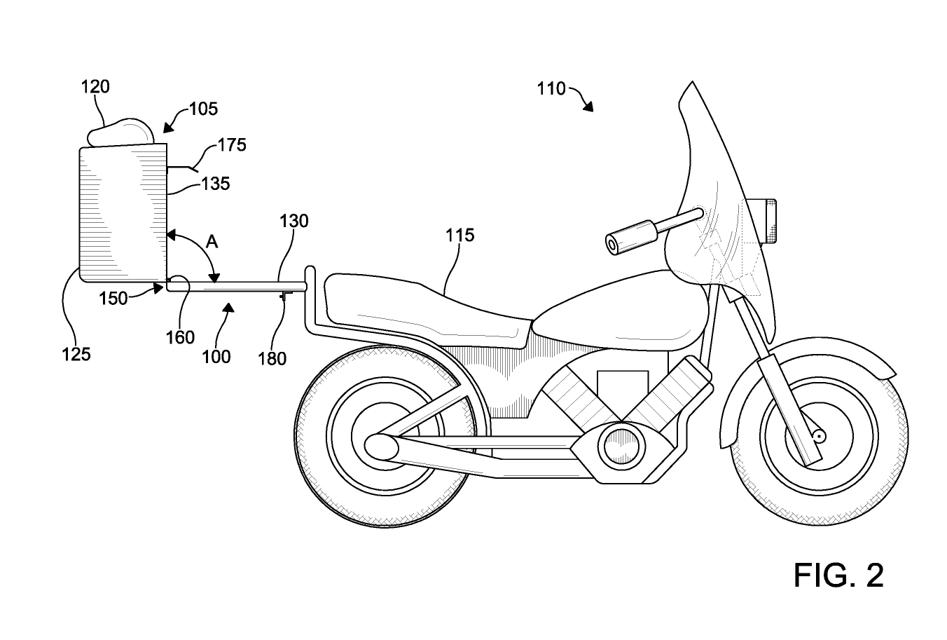

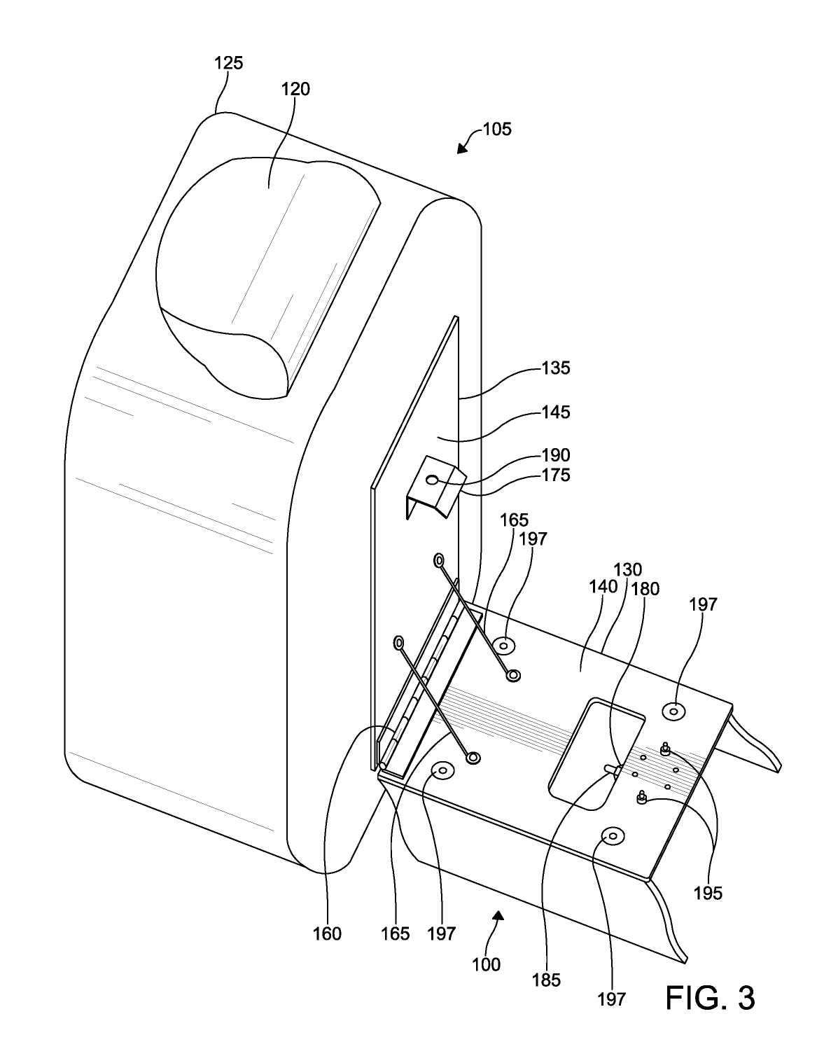

With reference to FIGS. 1-3, a first embodiment of a pivotable adaptor is shown at 100, where the pivotable adaptor 100 couples an accessory 105 to a vehicle 110, the accessory 105 positioned adjacent a saddle-type seat 115 on the vehicle 110. The accessory 105 is a combination backrest 120 and baggage 125 system. The vehicle 110 is shown as a motorcycle, but any vehicle with a saddle-type seat 115 can be used with the present technology, such as a bicycle, scooter, trike, all-terrain vehicle (ATV), snowmobile, or personal water craft (PWC). The pivotable adaptor 100 includes a first member 130 and a second member 135. The first member 130 is configured to be coupled to the vehicle 110, for example, by reversibly attaching to a preexisting luggage rack, frame member, and or seat mount of the vehicle 110. The second member 135 is configured to be coupled to the accessory 105, wherein the second member 135 is pivotably coupled to the first member 130 and is configured to pivot away from the saddle-type seat 115 on the vehicle 110. For example, the second member 135 can pivot about angle A shown in FIG. 2.

The first member 130 comprises a first substantially planar plate 140 and the second member 135 comprises a second substantially planar plate 145. The second member 135 is configured to pivot from a first position 150 adjacent the first member (shown in FIG. 1) to a second position 155 (shown in FIG. 2) away from the first member 130 and away from the saddle-type seat 115 on the vehicle 110. As shown in FIG. 1, the first member 130 and the second member 135 are substantially parallel in the first position 150. As shown in FIG. 2, the second member 135 pivots about angle A between the first and second positions 150, 155. Angle A between the first member 130 and the second member 135 can define an angle of at least about 60 degrees in the second position 155, whereas shown in FIG. 2, angle A can be about 90 degrees or slightly more than 90 degrees.

The first embodiment of the pivotable adaptor 100 has the first member 130 and the second member 135 pivotably coupled by a hinge 160. As shown, the hinge 160 substantially spans a length of one side of the first member 130 and substantially spans a length of one side of the second member 135. However, the hinge 160 can be smaller or substituted with two or more hinges or another type of pivotable coupling.

The pivotable adaptor 100 further includes a limiter 165 configured to limit a distance that the second member 135 can pivot away from the saddle-type seat 115 on the vehicle 110. As shown, the limiter 165 includes two flexible cables that are drawn tight upon pivoting the second member 135 a distance away from the saddle-type seat 115 upon reaching the limit of angle A. The two cables of the limiter 165 are each coupled to the first member 130 and the second member 135.

A catch 170 is included in the pivotable adaptor 100, where the catch 170 is configured to prevent the second member 135 from pivoting with respect to the first member 130. The catch 170 as shown includes a tab 175 that is held by a release 180, where the release 180 can include a spring-loaded pin 185 that is received by an aperture 190 within the tab 175. The catch 170 operates to secure the first member 130 adjacent the second member 135 when the vehicle 110 is in operation to prevent pivoting of the second member 135 away from the saddle-type seat 115.

Two anti-vibration devices 195 are coupled to the first member 130 and are configured to contact the second member 135 when the second member 135 is in the first position 150. The anti-vibration devices 195 prevent vibration between the first member 130 and the second member 135 when the vehicle 110 is operation to reduce noise, vibration, and harshness. As shown, the anti-vibration devices 195 are spring-loaded protuberances that maintain contact between the first member 130 and the second member 135 when the second member 135 is in the first position 150. Reversible couplings 197 are used to couple the first member 130 to the vehicle 110.

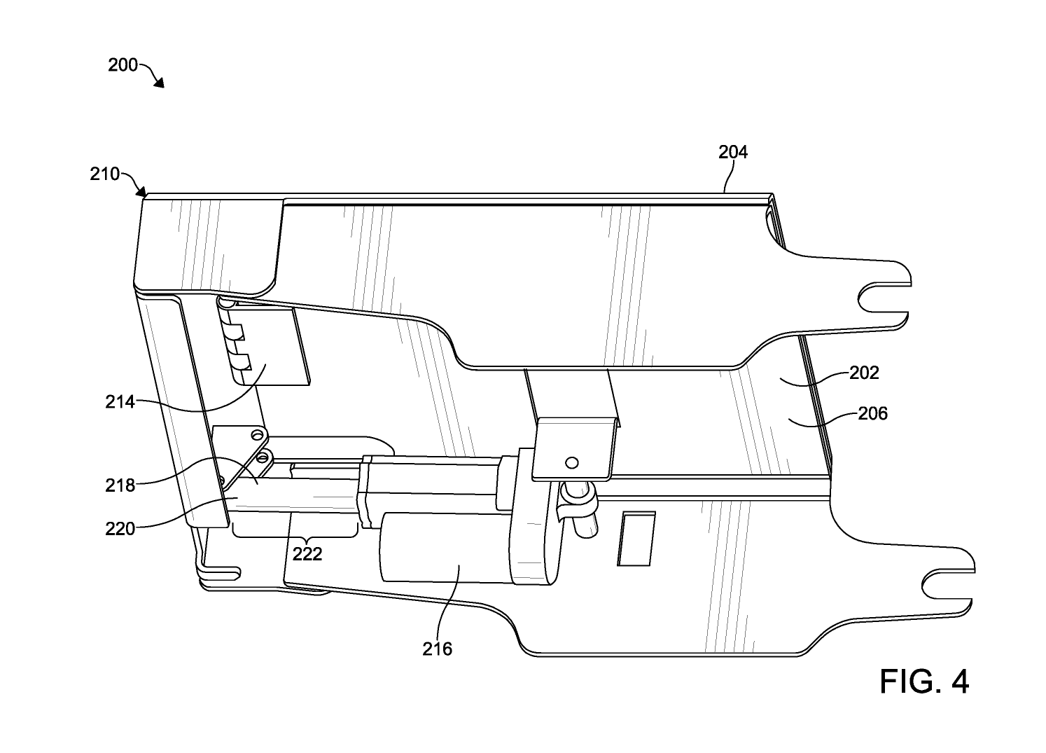

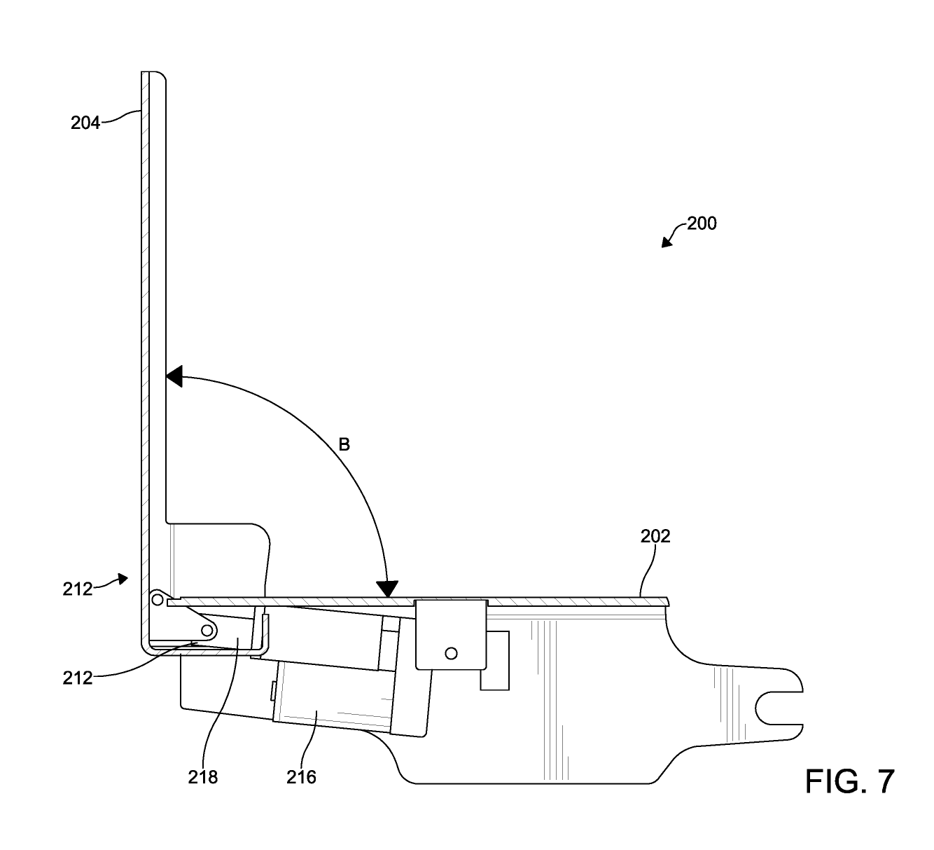

With reference to FIGS. 4-7, a second embodiment of a pivotable adaptor is shown at 200, where the pivotable adaptor 200 is used to couple an accessory to a vehicle, the accessory positioned adjacent a saddle-type seat on the vehicle, as shown for the accessory 105, vehicle 110, and saddle-type seat 115 in FIGS. 1-3. The pivotable adaptor 200 has a first member 202 and a second member 204. The first member 202 is configured to be coupled to the vehicle 110 and the second member 204 is configured to be coupled to the accessory 105. The second member 204 is pivotably coupled to the first member 202 and is configured to pivot away from the saddle-type seat 115 on the vehicle 110. For example, the second member 202 can pivot about angle B shown in FIG. 7.

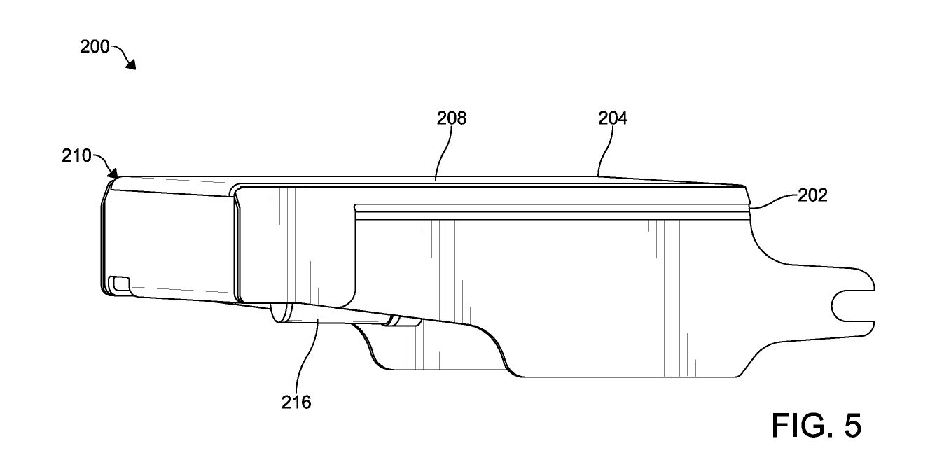

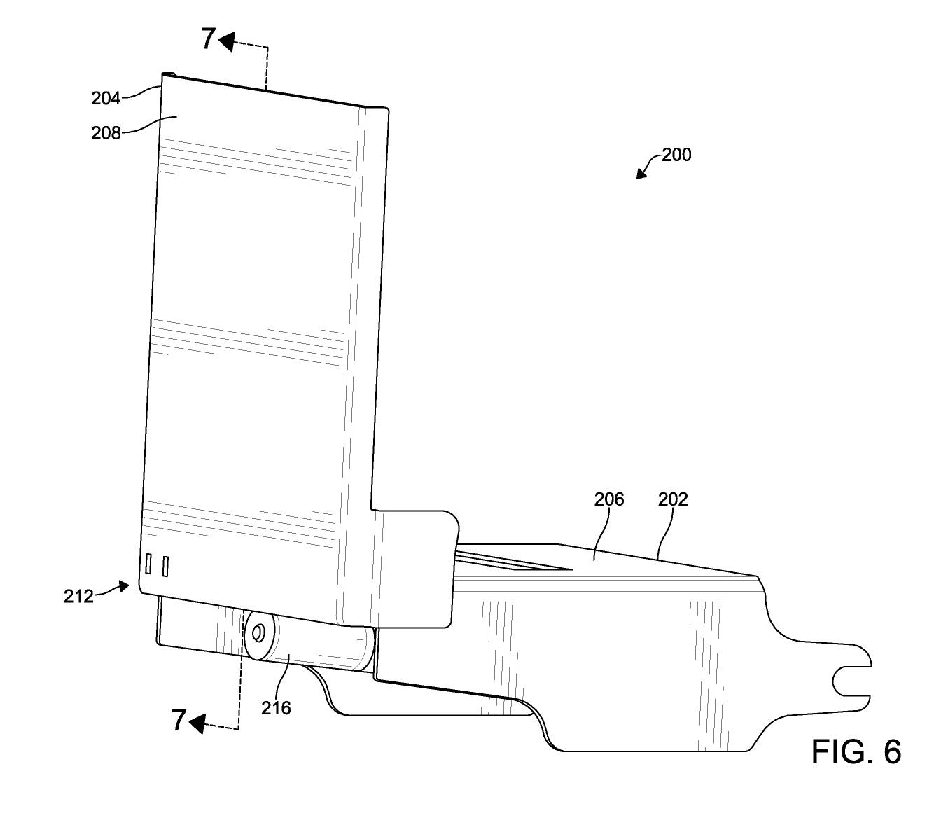

The first member 202 includes a first substantially planar plate 206 and the second member 204 includes a second substantially planar plate 208, where the second member 204 is configured to pivot from a first position 210 adjacent the first member 204 (shown in FIGS. 4 and 5) to a second position 212 (shown in FIGS. 6 and 7) away from the first member 202 and away from the saddle-type seat 115 on the vehicle 110. As can be seen in FIGS. 4 and 5, the first member 202 and the second member 204 are substantially parallel in the first position 210. As shown in FIGS. 6 and 7, the second member 204 pivots about angle B between the first and second positions 210, 212. Angle B between the first member 202 and the second member 204 can define an angle of at least about 60 degrees in the second position 212, whereas shown in FIG. 7, angle B can be about 90 degrees or slightly more than 90 degrees. The first member 202 and the second member 204 are pivotably coupled by a hinge 214.

The pivotable adaptor 200 includes an actuator 216 configured to pivot the second member 204 with respect to the first member 202. The actuator 216 is coupled to the first member 202 and includes a translation member 218 coupled to the second member 204. The actuator 216 is configured to move the translation member 218 thereby pivoting the second member 204 with respect to the first member 202. In particular, the translation member 218 includes a distal end 220 and the actuator 216 is configured to move the translation member 216 by changing a distance between the distal end 220 of the translation member 218 and a remainder of the actuator 216. As shown, the second embodiment of the pivotable adaptor 200 moves the distal end 220 of the translation member 218 toward the remainder of the actuator 216; i.e., the translation member 218 is withdrawn into the actuator 216. Bringing the distal end 220 toward the remainder of the actuator 216 causes the second member 204 to pivot with respect to the first member 202 and pivot away from the saddle-type seat 115 on the vehicle 110 from the first position 210 toward the second position 212. The hinge 214 acts as a pivot point between the first member 202 and the second member 204 about which the second member 204 is pivotably coupled to the first member 202, where the second member 204 and is configured to pivot away from the saddle-type seat 115 on the vehicle 110. The translation member 218 of the actuator 216 extends across or past the hinge 214 in the first position 210 and is drawn toward a remainder of the actuator 216 when moved to pivot the second member 204 to the second position 212. The actuator 216 is configured to be powered by the vehicle 110 and can include an electrical coupling (not shown) to plug into the vehicle's electrical system.

The second embodiment of the pivotable adaptor 200 can also include a cut-off switch incorporated therein that is configured to render the actuator 216 inoperable when the vehicle 110 is in operation. The actuator 216 is also configured to receive a wireless signal to pivot the second member 204 with respect to the first member 202. In this way, a remote wireless control can be used to pivot the second member 204 away from and back towards the saddle-type seat 115 on the vehicle 110 between the first and second positions 210, 212. The translation member 218 can have a length 222 or another portion of the actuator 216 can present a physical or mechanical limit that functions as a limiter that limits a distance that the second member 204 can pivot away from the saddle-type seat 115 on the vehicle 110.

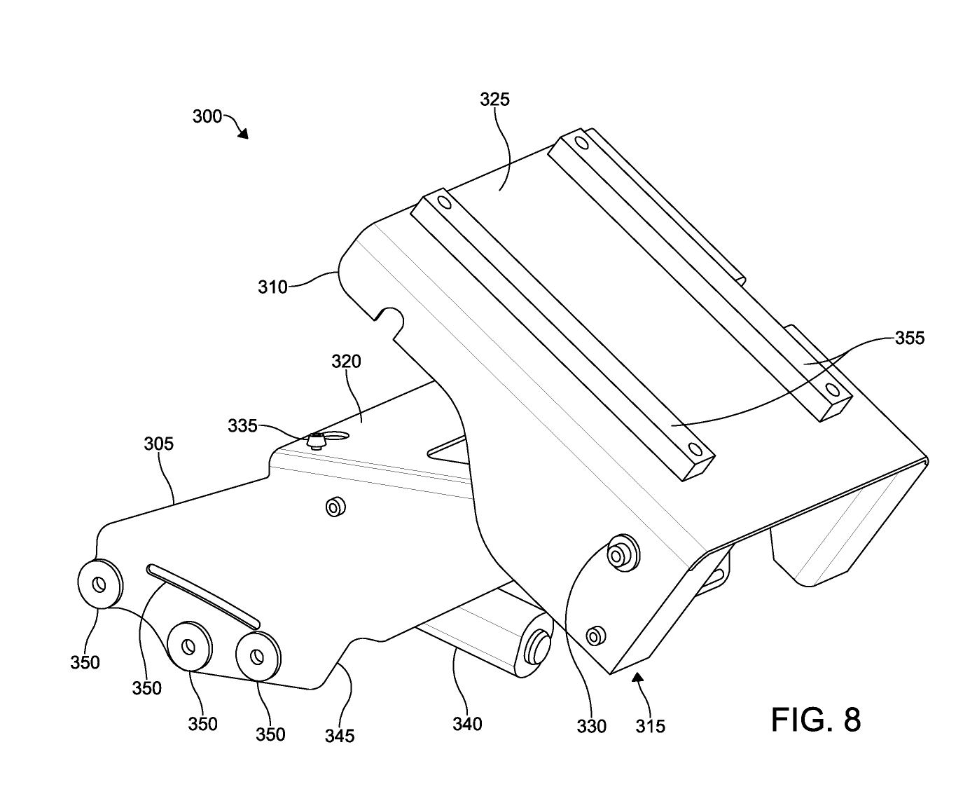

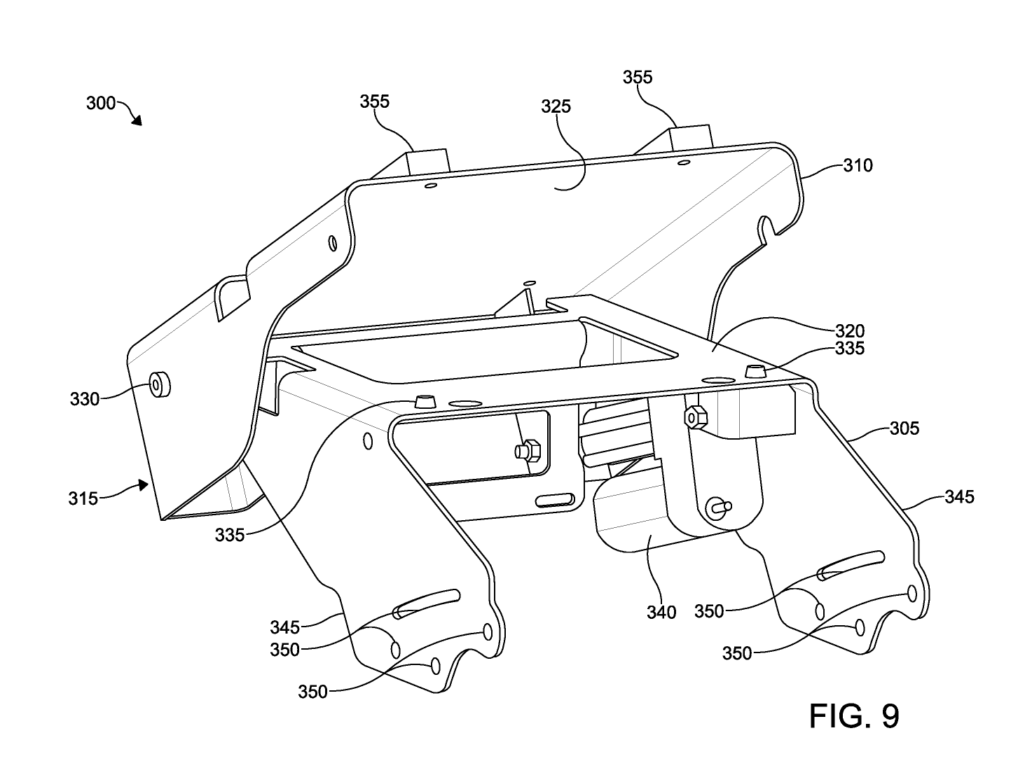

With reference to FIGS. 8-9, a third embodiment of a pivotable adaptor is shown at 300, where the pivotable adaptor 300 is used to couple an accessory to a vehicle, the accessory positioned adjacent a saddle-type seat on the vehicle, as shown for the accessory 105, vehicle 110, and saddle-type seat 115 in FIGS. 1-3. The pivotable adaptor 300 comprises a first member 305 configured to couple to the vehicle 110. The pivotable adaptor 300 also comprises a second member 310 configured to couple to the accessory 105. The second member 310 is pivotably coupled to the first member 305 and is configured to pivot away from the saddle-type seat 115 on the vehicle 110. The second member 310 is shown in an intermediate or partially pivoted position 315 in FIGS. 8-9.

The first member 305 includes a first substantially planar plate 320 and the second member 310 includes a second substantially planar plate 325. The second member 310 is configured to pivot away from the saddle-type seat 115 on the vehicle 110. The second member 310 can pivot in a similar manner as shown for the first and second embodiments of the pivotable adaptors 100, 200, where pivoting can occur between an analogous first position 150, 210 adjacent the first member 305 to an analogous second position 155, 212 away from the first member 305. In a similar manner, the first member 305 and second member 310 can define an angle, such as angles A and B shown between the first members 130, 202 and the second members 135, 204 for the first and second embodiments of the pivotable adaptors 100, 200, respectively. As such, pivoting of the second member 310 can define an angle of at least about 60 degrees, about 90 degrees, or slightly more than 90 degrees despite the depiction of the intermediate or partially pivoted position 315 shown in FIGS. 8-9. The first member 305 and the second member 310 are therefore substantially parallel in the first position, as per the first and second embodiments of the pivotable adaptors 100, 200, respectively.

The first member 305 and the second member 305 are pivotably coupled by two bushings 330 that operate as pivot points. The bushings 330 can be configured as dry-running, lubrication free, and corrosion resistant bushings formed with various polymers, stainless steel, and/or plated metal components. The pivotable adaptor 300 also includes a first anti-vibration device 335 coupled to the first member 305 that contacts the second member 310 when the second member 310 is adjacent the first member 305 or pivoted to be in the first position. Two instances of the first anti-vibration device 335 are shown that serve to minimize vibration between the first member 305 and the second member 310; however, a single anti-vibration device 335 or more than two anti-vibration devices 335 can be used.

Much in the same fashion as shown for the second embodiment of the pivotable adaptor 200, the third embodiment of the pivotable adaptor 300 includes an actuator 340 configured to pivot the second member 310 with respect to the first member 305. The actuator 340 is coupled to the first member 305 and includes a translation member (not shown) coupled to the second member 310. The translation member can be analogous to the translation member 218 shown for the second embodiment of the pivotable adaptor 200. The actuator 340 is likewise configured to move the translation member thereby pivoting the second member 310 with respect to the first member 305. Again with reference to the second embodiment of the pivotable adaptor 200, the translation member includes a distal end and the actuator 340 is configured to move the translation member by changing a distance between the distal end of the translation member and a remainder of the actuator 340. The bushings 330 operate as pivot points between the first member 305 and the second member 310 about which the second member 310 is pivotably coupled to the first member 305 and is configured to pivot away from the saddle-type seat 115 on the vehicle 110, where one of the actuator 340 and the translation member extends across the pivot points.

The pivotable adaptor 300 includes two mounting plates 345 that are integrally formed therewith that serve to mount the pivotable adaptor 300 to the vehicle 110 and/or the saddle-type seat 115. As shown, the mounting plates 345 are integrally formed as portions of the first member 305. However, the mounting plates 345 can be separate components that are permanently or reversibly coupled to the first member 305. The mounting plates 345 have various attachment points 350 to allow the pivotable adaptor 300 to be coupled to the vehicle 110 and/or the saddle-type seat 115. Alternatively, the attachment points 350 can be coupled to an adaptor (not shown), where the adaptor is coupled to the vehicle 110 and/or the saddle-type seat 115, allowing the pivotable adaptor 300 to be mounted on a particular vehicle 110 and/or the saddle-type seat 115 configuration. The mounting plate 345, for example, could have a universal configuration of attachment points 350 that couple to particular adaptors for specific vehicles 110 and/or saddle-type seats 115. FIGS. 8-9 show two mounting plates 345, but a single mounting plate 345 or more than two mounting plates 345 can be used.

The second member 310 includes two accessory mounts 355 for attachment of the accessory 105 thereto. A single accessory mount 355 or more than two accessory mounts 355 can be used and the accessory mount(s) 355 can operate in conjunction with various accessory adaptors (not shown) to couple various accessories, such as backrests and/or baggage systems, to the pivotable adaptor 300. The accessory mounts 355 can also include or be configured as second anti-vibration devices to minimize noise, vibration, and harshness between the pivotable adaptor 300 and the accessory 105.

In an analogous fashion to the second embodiment of the pivotable adaptor 200, the third embodiment of the pivotable adaptor can have the actuator 340 configured to be powered by the vehicle 110 and can include an electrical coupling (not shown) to plug into the vehicle's electrical system. The pivotable adaptor 300 can also include a cut-off switch incorporated therein that is configured to render the actuator 340 inoperable when the vehicle 110 is in operation. The actuator 340 is also configured to receive a wireless signal to pivot the second member 310 with respect to the first member 305. In this way, a remote wireless control can be used to pivot the second member 310 away from and back towards the saddle-type seat 115 on the vehicle 110 between the first and second positions. The translation member can have a length or another portion of the actuator 340 can present a physical or mechanical limit that functions as a limiter that limits a distance that the second member 310 can pivot away from the saddle-type seat 115 on the vehicle 110.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A pivotable adaptor for an accessory coupled to a vehicle, the accessory positioned adjacent a saddle-type seat on the vehicle, the pivotable adaptor comprising:
a first member configured to couple to the vehicle; and
a second member configured to couple to the accessory, wherein the second member is pivotably coupled to the first member and is configured to pivot away from the saddle-type seat on the vehicle.

2. The pivotable adaptor of claim 1, wherein the first member comprises a first substantially planar plate, the second member comprises a second substantially planar plate, and the second member is configured to pivot from a first position adjacent the first member to a second position away from the first member and away from the saddle-type seat on the vehicle.

3. The pivotable adaptor of claim 2, wherein the first member and the second member are substantially parallel in the first position.

4. The pivotable adaptor of claim 2, wherein the first member and the second member define an angle of at least about 60 degrees in the second position.

5. The pivotable adaptor of claim 1, wherein the first member and the second member are pivotably coupled by a hinge.

6. The pivotable adaptor of claim 1, wherein the first member and the second member are pivotably coupled by a bushing.

7. The pivotable adaptor of claim 1, further comprising a limiter, the limiter configured to limit a distance that the second member can pivot away from the saddle-type seat on the vehicle.

8. The pivotable adaptor of claim 7, wherein the limiter is coupled to a member selected from the group consisting of the first member, the second member, and combinations thereof.

9. The pivotable adaptor of claim 1, further comprising a catch configured to prevent the second member from pivoting with respect to the first member.

10. The pivotable adaptor of claim 1, further comprising an anti-vibration device configured to prevent vibration of a member selected from the group consisting of the first member, the second member, and combinations thereof.

11. The pivotable adaptor of claim 10, wherein the anti-vibration device contacts the first member and the second member.

12. The pivotable adaptor of claim 1, further comprising an actuator configured to pivot the second member with respect to the first member.

13. The pivotable adaptor of claim 12, wherein the actuator is coupled to one of the first member and the second member, the actuator including a translation member coupled to the other of the first member and the second member, the actuator configured to move the translation member thereby pivoting the second member with respect to the first member.

14. The pivotable adaptor of claim 13, wherein the translation member includes a distal end and the actuator is configured to move the translation member by changing a distance between the distal end of the translation member and a remainder of the actuator.

15. The pivotable adaptor of claim 13, further comprising a pivot point between the first member and the second member about which the second member is pivotably coupled to the first member and is configured to pivot away from the saddle-type seat on the vehicle, wherein one of the actuator and the translation member extends across the pivot point in the.

16. The pivotable adaptor of claim 12, wherein the actuator is configured to be powered by the vehicle.

17. The pivotable adaptor of claim 16, further comprising a cut-off switch configured to render the actuator inoperable when the vehicle is in operation.

18. The pivotable adaptor of claim 12, wherein the actuator is configured to receive a wireless signal to pivot the second member with respect to the first member.

19. A pivotable accessory configured to be positioned adjacent a saddle-type seat on a vehicle, the pivotable accessory comprising:
an accessory; and
a pivotable adaptor including:
a first member configured to couple to the vehicle; and
a second member coupled to the accessory, wherein the second member is pivotably coupled to the first member and is configured to pivot away from the saddle-type seat on the vehicle.

20. The pivotable accessory of claim 19, wherein the accessory is a member selected from the group consisting of a backrest, a baggage, and combinations thereof.

21. A vehicle comprising:
a saddle-type seat;
a pivotable accessory positioned adjacent the saddle-type seat, the pivotable accessory including:
an accessory; and
a pivotable adaptor including:
a first member coupled to the vehicle; and
a second member coupled to the accessory, wherein the second member is pivotably coupled to the first member and is configured to pivot away from the saddle-type seat on the vehicle.

22. The vehicle of claim 21, wherein the vehicle is a motorcycle.

23. A method of improving access to a saddle-type seat on a vehicle, a pivotable accessory positioned adjacent the saddle-type seat, the method comprising:
pivoting the pivotable accessory away from the saddle-type seat.

24. The method of claim 23, wherein:
the pivotable accessory comprises:
an accessory; and
a pivotable adaptor including:
a first member configured to couple to the vehicle; and
a second member coupled to the accessory, wherein the second member is pivotably coupled to the first member and is configured to pivot away from the saddle-type seat on the vehicle;
and
pivoting the pivotable accessory away from the saddle-type seat includes pivoting the second member away from the saddle-type seat on the vehicle.
